(19) United States
(12) Patent Application Publication
(10) Pub. No.: US 2015/0193851 A1
(43) Pub. Date: Jul. 9, 2015

(54) METHOD, SERVER, CLIENT TERMINAL, AND ELECTRONIC COMMERCE SYSTEM FOR PRODUCT COMPARISON

(71) Applicant: TENCENT TECHNOLOGY (SHENZHEN)COMPANY LIMITED, Shenzhen, Guangdong (CN)

(72) Inventors: Yuguo Hua, Shenzhen (CN); Fei Ling, Shenzhen (CN); Zhao Tang, Shenzhen (CN); Yongyou Huang, Shenzhen (CN); Jian Ma, Shenzhen (CN); Liqi Wu, Shenzhen (CN); Sheng Long, Shenzhen (CN)

(21) Appl. No.: 14/352,340

(22) PCT Filed: Dec. 6, 2013
(86) PCT No.: PCT/CN2013/088776

§ 371 Date: Apr. 17, 2014

(30) Foreign Application Priority Data
Mar. 27, 2013 (CN) 201310102348.7

(51) Int. Cl. G06Q 30/06

(52) U.S. Cl. CPC G06Q 30/0629

(57) ABSTRACT

A method for product comparison is described, including: receiving a product comparison request sent by a client terminal, the product comparison request carrying identification information of at least two products to be compared; pulling attribute information of each of the at least two products according to the identification information of each of the at least two products; calculating an integrated score of each of the at least two products according to the attribute information of each of the at least two products; and generating comparison information of the at least two products, and returning the comparison information to the client terminal. Further, a server, a client terminal, and an electronic commerce system are also described. A comparison conclusion can be visually presented in comparison information of products, improving the actual effect and usage rate of the product comparison and enhancing the intelligence of the electronic commerce system.

### CROSS-REFERENCE TO RELATED APPLICATIONS

This application claims the benefit of priority from Chinese Patent Application NO. 201310102348.7, entitled “METHOD, SERVER, CLIENT TERMINAL, AND ELECTRONIC COMMERCE SYSTEM FOR PRODUCT COMPARISON” and filed on Mar. 27, 2013, the content of which is hereby incorporated in its entire by reference.

### FIELD

The present disclosure relates to technical field of internet; in particular, to technical field of electronic commerce; and more particularly, to a method, a server, a client terminal, and an electronic commerce system for product comparison.

### BACKGROUND

At present, product comparisons of standardizable-type products can be realized in an electronic commerce system. The standardizable-type products generally refer to products which are able to be classified standardizedly, for example, products with explicit standard parameters, such as digital products, books, cosmetics, etc. When a product comparison of standardizable-type products is performed in an electronic commerce system, usually only attribute information of the products being compared will be listed in a comparison page, the attribute information including price information, promotion information, comment information, and so on. However, no comparison conclusion will be provided. It is unfavorable for helping a user to make a purchase decision, reducing the actual effect and usage rate of the product comparison and the intelligence of the electronic commerce system.

### SUMMARY

Exemplary embodiments of the present invention provide a method, a server, a client terminal, and an electronic commerce system for product comparison, in which a comparison conclusion can be visually presented in comparison information of products, improving the actual effect and usage rate of the product comparison and enhancing the intelligence of the electronic commerce system.

According to a first aspect of the invention, it is provided a method for product comparison, which may comprise:

receiving, at a server, a product comparison request sent by a client terminal, the product comparison request carrying identification information of at least two products which are to be compared;
pulling, at the server, attribute information of each of the at least two products according to the identification information of each of the at least two products;
calculating, at the server, an integrated score of each of the at least two products according to the attribute information of each of the at least two products; and
generating, at the server, comparison information of the at least two products, and returning the comparison information to the client terminal, the comparison information comprising the attribute information and the integrated score of each of the at least two products.

According to a second aspect of the invention, it is provided a method for product comparison, which may comprise:

obtaining, at a client terminal, identification information of at least two products which are to be compared when the client terminal detects a product comparison operation in an electronic commerce system;
sending, at the client terminal, a product comparison request carrying the identification information of the at least two products to a server, so as to make the server pull attribute information of each of the at least two products, calculate an integrated score of each of the at least two products, and generate comparison information of the at least two products to send the comparison information to the client terminal; and
outputting, at the client terminal, the comparison information of the at least two products in a comparison page, the comparison information being returned by the server.

According to a third aspect of the invention, it is provided a server, which may comprise:

a request receiving module, which is configured to receive a product comparison request send by a client terminal, the product comparison request carrying identification information of at least two products which are to be compared;
an attribute pulling module, which is configured to pull attribute information of each of the at least two products according to the identification information of each of the at least two products;
a score calculating module, which is configured to calculate an integrated score of each of the at least two products according to the attribute information of each of the at least two products;
a comparing module, which is configured to generate comparison information of the at least two products, the comparison information comprising the attribute information and the integrated score of each of the at least two products; and
an information returning module, which is configured to send the comparison information of the at least two products to the client terminal.

According to a fourth aspect of the invention, it is provided a client terminal, which may comprise:

an identification obtaining module, which is configured to obtain identification information of at least two products which are to be compared when the client terminal detects a product comparison operation in an electronic commerce system;
a comparing module, which is configured to send a product comparison request carrying the identification information of the at least two products to a server, so as to make the server pull attribute information of each of the at least two products, calculate an integrated score of each of the at least two products, and generate comparison information of the at least two products to send the comparison information to the client terminal; and
an information outputting module, which is configured to output comparison information of the at least two products in a comparison page, the comparison information being sent by the server.

According to a fifth aspect of the invention, it is provided an electronic commerce system, which may comprise a server provided in the third aspect and at least one client terminal provided in the fourth aspect.

In exemplary embodiments of the present invention, the server may pull attribute information of at least two products which are requested to be compared, calculate an integrated score of each product, and generate comparison information including the attribute information and the integrated score of each product. The attribute information included in the comparison information of the product can clearly present to a user key comparison points, and the integrated score included in the comparison information of the product can visually present to the user a comparison conclusion to assist the user in making a purchase decision. Thus, the actual effect and, usage rate of the product comparison can be improved, and the intelligence of the electronic commerce system can be enhanced. Moreover, the user viscosity and the transaction rate of the electronic commerce system can be increased effectively.

### BRIEF DESCRIPTION OF THE DRAWINGS

The accompanying drawings are presented to aid in the description of embodiments of the invention and are provided solely for illustration of the embodiments and not limitation thereof.

FIG. 1 is a flowchart of a method for product comparison provided in one embodiment of the present invention;

FIG. 2 is a flowchart of an embodiment of step S103 shown in FIG. 1;

FIG. 3 is a flowchart of a method for product comparison provided in another embodiment of the present invention;

FIG. 4a is an effect schematic diagram of a product comparison provided in yet another embodiment of the present invention;

FIG. 4b is an effect schematic diagram of a product comparison provided in yet another embodiment of the present invention;

FIG. 4c is an effect schematic diagram of a product comparison provided in yet another embodiment of the present invention;

FIG. 5 is a structure schematic diagram of a server provided in yet another embodiment of the present invention;

FIG. 6 is a structure schematic diagram of a score calculating module shown in FIG. 5;

FIG. 7 is a structure schematic diagram of a client terminal provided in yet another embodiment of the present invention.

### DETAILED DESCRIPTION

The present invention is hereinafter described further in detail with reference to the accompanying drawings so as to make the objective, technical solution, and merits of exemplary embodiments more apparent. The term “exemplary” used throughout this description means “serving as an example, instance, or illustration,” and should not necessarily be construed as preferred or advantageous over other exemplary embodiments. It would be apparent that a person having ordinary skills in the art may obtain other embodiments based on the illustrated exemplary embodiments of the invention without paying any creative work, and these embodiments should also be within the protection scope sought by the present invention.

In embodiments of the present invention, a client terminal may be any one of a PC (Personal Computer), a mobile phone, a smart phone, a tablet computer, an e-reader, a laptop, etc. An electronic commerce system may contain standardizable-type products and non-standardizable-type products, wherein, standardizable-type products generally refer to products which are able to be classified standardizedly, for example, products which have explicit standard parameters and whose prices are transparent and easy to be compared, such as digital products, books, cosmetics, etc. Non-standardizable-type products generally refer to products which are unable to classified standardizely, for example, products which have no explicit standard attribute parameters and whose prices are difficult to be compared, such as clothing, foodstuff, accessories, household products, etc.

In existing electronic commerce systems, only product comparisons of standardizable-type products can be realized, while product comparisons of standardizable-type products cannot be performed. Usually, only attribute information of the products being compared was listed in a comparison page, and no conclusion of the comparison is provided. In an embodiment of the present invention, the method for product comparison can be applied to not only product comparisons of standardizable-type products in a electronic commerce system, but also product comparisons of non-standardizable-type products in the electronic commerce system. Furthermore, a comparison conclusion of products can be visually presented in comparison information, improving the actual effect and usage rate of product comparisons, and enhancing the intelligence of the electronic commerce system.

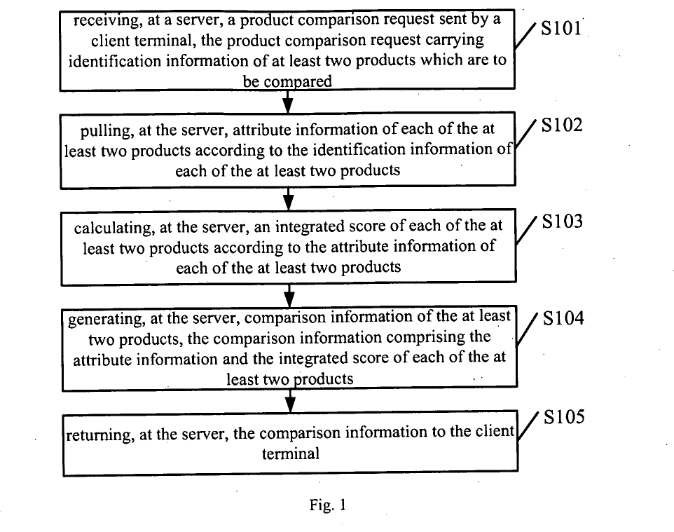

Detailed description of the methods for product comparison provided in embodiments of the present invention will be given below in conjunction with FIGS. 1-4.

Referring to FIG. 1, it is a flowchart of a method for product comparison provided in one embodiment of the present invention. In this embodiment, it is illustrated a process of a method for product comparison from a perspective of a server side, and the method may comprise the following steps: steps S101-S105.

Step S101 is, receiving, at a server, a product comparison request sent by a client terminal, the product comparison request carrying identification information of at least two products which are to be compared.

All of the at least two products may be standardizable-type products in an electronic commerce system, or all of the at least two products may be non-standardizable-type products in the electronic commerce system. Wherein, one product in the electronic commerce system corresponds to only one piece of identification information. The identification information of the product is used for identifying a unique product, and it may be an ID (Identity) of the product, a serial number of the product, etc.

Step S102 is, pulling, at the server, attribute information of each of the at least two products according to the identification information of each of the at least two products.

The server administrates attribute information of each product in the electronic commerce system, and the attribute information may include but not limited to: price information, comment information, product satisfaction information, promotion information, accumulated points information, feature information, product attention degree information, and so on. Wherein, the comment information may include but not limited to: the quantity of positive comments, the quantity of neutral comments, the quantity of negative comments, the quantity of all comments and contents of the comments. The product satisfaction information may include but not limited to: a discount rate, a size satisfaction degree, a comfort level, a trueness degree of a picture, and a trueness degree of a product description. In this step, the server pulls attribute information of each of the at least two products according to the identification information of each of the at least two products. It should be noted that, in this embodiment, comparison points which a user concerns about when the user performs a product comparison may be collected based on experiences, and all or part of the attribute information of each of the at least two products may be pulled according to the collection result.

Step S103 is, calculating, at the server, an integrated score of each of the at least two products according to the attribute information of each of the at least two products. In this step, the server calculates the integrated score of each of the at least two products by using the attribute information of each of the at least two products as a calculation factor of the integrated score of each product. It should be noted that, the integrated score may visually reflect the advantages and disadvantages of a product.

The higher the integrated score is, the higher the comprehensive performance of the product is, and the more the product is deserved of trust and purchasing.

Step S104 is, generating, at the server, comparison information of the at least two products, the comparison information comprising the attribute information and the integrated score of each of the at least two products.

Wherein, the comparison information of the at least two products is the comparison result of the at least two products. The comparison result includes not only attribute information of each of the at least two products, which clearly reflects key comparison points, but also the integrated score of each of the at least two products, which visually reflects the advantages and disadvantages of each product.

Step S105 is, returning, at the server, the comparison information to the client terminal.

In this step, after the server returns the comparison information to the client terminal, the client terminal may output the comparison information in a comparison page. The comparison information not only presents key comparison points of products clearly, but also presents a comparison result to the user visually, assisting a user in making a purchasing decision and increasing a transaction rate of the electronic commerce system.

In this embodiment of the present invention, the server pulls attribute information of at least two products which are requested to be compared, calculates an integrated score of each product, and generates comparison information including the attribute information and the integrated score of each product. The attribute information included in the comparison information of the product can clearly present to a user a key comparison point, and the integrated score included in the comparison information of the product can visually present to the user a comparison conclusion to assist the user in making a purchase decision. Thus, the actual effect and usage rate of the product comparison can be improved, and the intelligence of the electronic commerce system can be enhanced. Moreover, the user viscosity and the transaction rate of the electronic commerce system can be increased effectively.

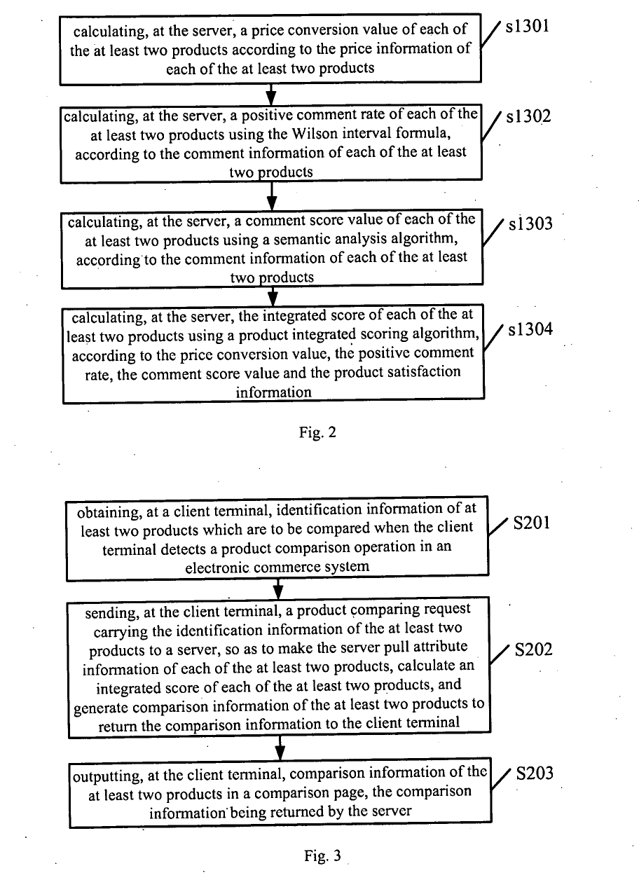

Referring to FIG. 2, it is a flowchart of step S103 shown in FIG. 1 provided in one embodiment of the present invention. This embodiment shows a process of calculating, at the server, the integrated score of each of the at least two products according to the attribute information of each of the at least two products which are to be compared. It should be noted that, in this embodiment, the attribute information includes: price information, comment information and product satisfaction information. Wherein, the comment information includes: the quantity of positive comments, the quantity of all comments, and the contents of the comments. The product satisfaction information includes: a discount rate, a size satisfaction degree, a comfort degree, and a trueness degree of a picture. As shown in FIG. 2, step S103 may specifically comprise the following steps: steps s1301-s1304.

s1301 is: calculating, at the server, a price conversion value of each of the at least two products according to the price information of each of the at least two products. Wherein, the price conversion value refers to a value obtained by converting the price of a product with a certain value as a base number value. The certain value may be set according to actual needs. For example, the certain value may be 100, 200, and so on. In this step, the process that the server calculates the price conversion value of each of the at least two products may comprise the following steps.

1) The server selects product m which corresponds to the highest price from the at least two products according to the price information of each of the at least two products, the price conversion value of product m may be expressed by the following formula:

Pₜᵣ_{ₘ}=M (1)

Wherein, Pₜᵣ_{ₘ} is the price conversion value of product m, M is the base number value, and m is a positive integer whose value is less than or equal to the total quantity of the at least two products which are to be compared.
2) The price conversion value of product i, which is any product of the at least two products except product m, may be calculated by the following formula:

$${P}_{{tr}_{i}} = \frac{{P}_{max} - {P}_{i}}{{P}_{i}} \cdot M \qquad ( 2 )$$

Wherein, Pₜᵣ_{ᵢ} is the price conversion value of product i, Pₘₐₓ is the price value of product m (namely the maximum price value), Pᵢ is the price value of product i, and i is a positive integer whose value is less than the total quantity of the at least two products which are to be compared.

s1302 is: calculating, at the server, a positive comment rate of each of the at least two products using the Wilson interval formula, according to the comment information of each of the at least two products.

In this step, the process that the server calculates the positive comment rate of any of the at least two products is described below.

11) The server calculates a positive comment percentage of product k according to the quantity of positive comments and the quantity of all comments which are included in the comment information of product k. The specific calculating formula may be as follow:

$${\hat{p}}_{k} = \frac{{n}_{{good}_{k}}}{{n}_{k}} \qquad ( 3 )$$

Wherein, \hat{p}ₖ is the positive comment percentage of product k, n_{good}_{ₖ} is the quantity of positive comments of product k, nₖ is the quantity of all comments of product k, and k is a positive integer whose value is less than or equal to the total number of the at least two products which are to be compared.

22) The server obtains the positive comment rate of product k by calculation using the Wilson interval formula according to the positive comment percentage and the quantity of all comments of product k. The calculating formula may be expressed as follow:

$${d}_{k} = \frac{{\hat{p}}_{k} + \frac{1}{2 {n}_{k}} {Z}_{1 - \frac{α}{2}}^{2} \sqrt{\frac{{\hat{p}}_{k} ( 1 - {\hat{p}}_{k} )}{{n}_{k}} + \frac{{Z}_{1 - \frac{α}{2}}^{2}}{4 {n}_{k}^{2}}}}{1 + \frac{1}{{n}_{k}} {Z}_{1 - \frac{α}{2}}^{2}} \qquad ( 4 )$$

Wherein, dₖ is the positive comment rate of product k, \hat{p}ₖ is the positive comment percentage of product k, nₖ is the quantity of all comments of product k, and

$${Z}_{1 - \frac{α}{2}}^{2}$$

is a constant which is a statistic of z under a certain confidence level. Generally, the statistic of z has a value of 1.96 under a confidence level of 95%.
According to 11) and 22) above, the server may obtains the positive comment rate of each of the at least two products by calculation.

s1303, calculating, at the server, a comment score value of each of the at least two products using a semantic analysis algorithm according to the comment information of each of the at least two products.

Wherein, the semantic analysis algorithm means analyzing semantics of keywords in a comment and giving a corresponding score value to each key word according to the analysis result. In this embodiment, score values corresponding to different key words may be set beforehand as follows according to actual situations.

TABLE 1
a semantic analysis algorithm table

| | Score Value |
|---|---|
| Key Words (semantics) | (total score is 10) |
| just so so, . . . | 5 |
| good, OK, consistent, satisfied, nice, . . . | 6 |
| pretty good, very good, very OK, very satisfied, . . . | 7 |
| great, excellent, very cheerful purchase, . . . | 8 |
| full marks, perfect, extremely good, super good, . . . | 10 |
| super bad, negative comment, . . . | 0 |
| bad, not good, . . . | 1 |
| . . . | . . . |

It should be noted that, all contents in table 1 are just for examples, and there may be other situations. For example, various key words that appear in contents of comments may be collected according to experience to update the key words in table 1. For another example, the score values in table 1 may be adjusted to be a 100-points system, or the specific score value corresponding to each key word may be adjusted according to actual situations. For the situations above, one may refer to the description of analysis for table 1, which will not be described here to avoid redundancy.

In step s1303, the server, firstly, extracts the key words from the comments of each product according to the comments of each of the at least two products. Secondly, the server reads the corresponding score value of each key word from the above table 1. Thirdly, the server calculates the total score value of all key words corresponding to each product to obtain the comment score value of each product. For example, the server extracts a first key word, a second key word, and a third key word for product k, which is any one of the at least two products. Then, a first score value, a second score value, and a third score value are obtains according to the above table 1. So, the comment score value of product k in this step is the sum of the first score value, the second score value, and the third score value.

s1304, calculating, at the server, the integrated score of each of the at least two products using a product integrated scoring algorithm, according to the price conversion value, the positive comment rate, the comment score value and the product satisfaction information.

In this step, the formula for calculating, at the server, the integrated score of any one of the at least two products, e.g. product k, is as follow:

Qⱼ=Pₜᵣ_{ⱼ}*w₁+(dⱼ+fⱼ)*w₂+(percentageⱼ+sizeⱼ+contortⱼ+accuracyⱼ)*w₃ (5)

Wherein, Qⱼ is the integrated score of product j, Pₜᵣ_{ⱼ} is the price conversion value of product j, w₁ is a price weight value, dⱼ is the positive comment rate of product j, fⱼ is the comment score value of product j, w₂ is a comment weight value, percentⱼ is the discount rate of product j, sizeⱼ is the size satisfaction degree of product j, comfortⱼ is the comfort level of product j, accuracyⱼ is the trueness degree of the picture of product j, and W₃ is an attribute weight value. It should be noted that, in the above formula (5), values of w₁, w₂ and w₃ may be set according to actual situations but they need to meet a rule of w₁+w₂+w₃=1, For instance, according to statistics or experiences, if in a product comparison process, a user concerns most about a price factor, followed by a comment factor and then another attribute factors, the value of w₁ may be set as the maximum and the value of w₂ may be set as a relatively large one, while the value of w₃ may be set as the minimum, e.g. the values of w₁, w₂ and w₃ may respectively be 0.6, 0.3 and 0.1. For another instance, according to statistics or experiences, if the user concerns most about the comment factor and not much about the price factor and other attribute factors, the value of w₂ may be set relatively larger and the value of w₁ and w₃ may be set relatively smaller, e.g. the values of w₁, w₂ and w₃ may respectively be 0.8, 0.1 and 0.1.

In this embodiment of the present invention, the server calculates the integrated score of each product according to the attribute information of the at least two products which are to be compared. In this way, the integrated score can be included in the comparison information of a product, presenting to a user the comparison conclusion visually to assist the user in making a purchase decision. Thus, the actual effect and usage rate of the product comparison can be improved, and, the intelligence of the electronic commerce system can be enhanced. Moreover, the user viscosity and the transaction rate of the electronic commerce system may be increased effectively. Referring to FIG. 3, it is a flowchart of a method for product comparison provided in yet another embodiment of the present invention. In this embodiment, it is illustrated a method for product comparison from a perspective of a client terminal side, and the method may comprise the following steps: steps S201-S203.

Step S201 is, obtaining, at a client terminal, identification information of at least two products which are to be compared when the client terminal detects a product comparison operation in an electronic commerce system.

At present, in a electronic commerce system, it is usually provided an option for product comparison operation, for example: an option of “product comparison”, an option of “compare products”, and so on. A user may select at least two products to perform a product comparison according to the option for product comparison operation provided in the electronic commerce system. In this step, the client terminal obtains the identification information of the at least two products which are to be compared when detecting a product comparison operation in the electronic commerce system. All of the at least two products may be standardizable-type products in the electronic commerce system, or all of the at least two products may be non-standardizable-type products in the electronic commerce system. Wherein, one product in the electronic commerce system corresponds to only one piece of identification information. The identification information of the product is used for identifying one product uniquely and it may be an ID of the product, a serial number of the product, etc.

Step S202 is, sending, at the client terminal, a product comparison request carrying the identification information of the at least two products to a server, to make the server pull attribute information of each of the at least two products, calculate an integrated score of each of the at least two products, and generate comparison information of the at least two products to return the comparison information to the client terminal.

In this step, the client terminal sends a product comparison request to the server, the product comparison request carrying the identification information of the at least two products which are to be compared. It should be noted that, after receiving the product comparison request sent by the client terminal, the server will perform the process of pulling the attribute information of the product, calculating the integrated score of the product, generating the comparison information of the product and returning the comparison information to the client terminal. For the process above, one may refer to relevant description of embodiments shown in FIGS. 1 and 2, which will not be described here to avoid redundancy.

Step S203 is, outputting, at the client terminal, comparison information of the at least two products in a comparison page, the comparison information being returned by the server.

In this step, the client terminal outputs the comparison information of the at least two products in a comparison page. Then, by browsing the comparison information in the comparison page, a user may not only know clearly key comparison points between products, but also obtain a comparison conclusion on the products. Thus, the user may make a purchase decision easily and the transaction rate of the electronic commerce system can be increased.

In this embodiment of the present invention, when detecting a product comparison operation in the electronic commerce system, the client terminal obtains the identification information of the at least two products which are to be compared and outputs the comparison information of the at least two products in the comparison page, the comparison information being sent by the server. Wherein, the attribute information of products included in the comparison information can clearly present to a user the key comparison points, and the integrated scores of the products included in the comparison information can visually present to the user a comparison conclusion to assist the user in making a purchase decision. Thus, the actual effect and usage rate of the product comparison can be improved, and the intelligence of the electronic commerce system can be enhanced. Moreover, the user viscosity and the transaction rate of the electronic commerce system can be increased effectively.

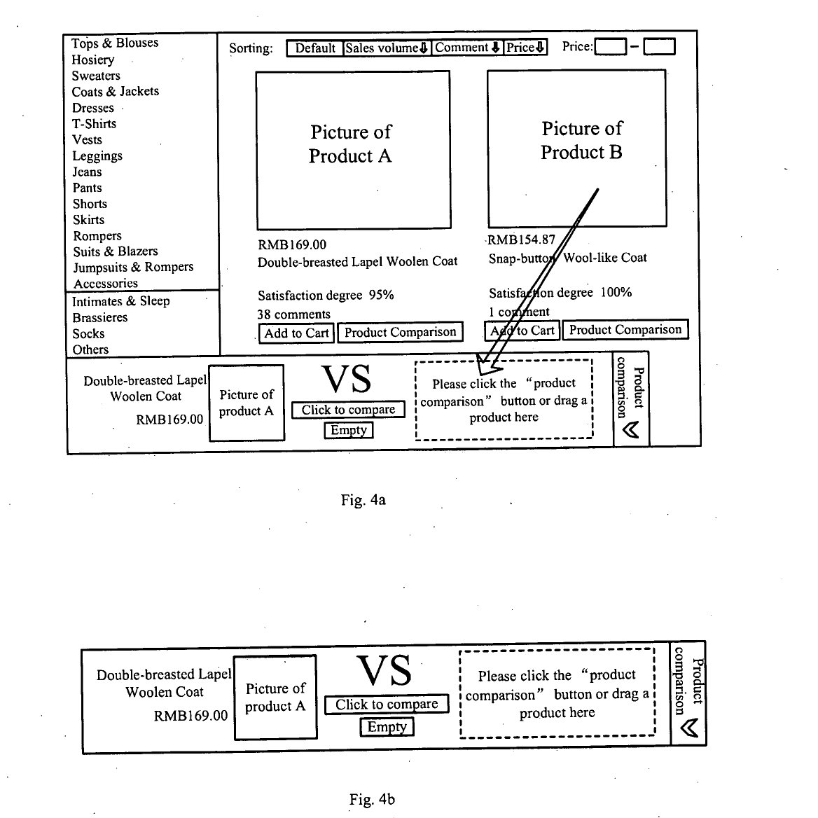

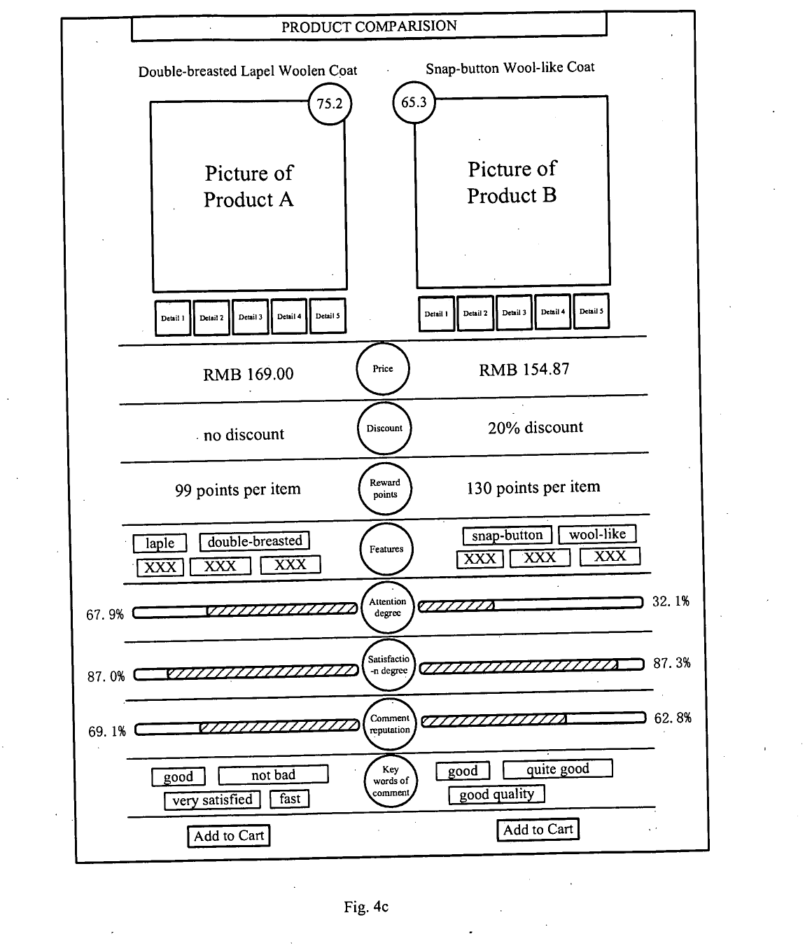

Below, a specific example of the method for product comparison will be described as an interaction between a server and a client terminal in conjunction with FIG. 4. In the embodiment below, it is described a product comparison between product A and product B, wherein, product A is a “Double-breasted lapel woolen coat” and product B is a “Snap-button wool-like coat”.

Referring to FIG. 4a, it is an effect schematic diagram of a product comparison provided in yet another embodiment of the present invention. As shown in FIG. 4a, a user may click a “product comparison” button or dragging the products to select product A and product B which are to be compared.

Referring to FIG. 4b, it is an effect schematic diagram of a product comparison provided in yet another embodiment of the invention. Product A and product B which are selected by the user to compare are put into a “product comparison box” in the electronic commerce system. A client terminal obtains IDs of product A and product B, respectively, in the “product comparison box”. The client terminal sends the IDs of product A and product B to the server.

The server pulls attribute information of product A according to the ID of product A and calculates an integrated score of product A according to the attribute information. For the calculating process, one may refer to description of the embodiment shown in FIG. 2. In this embodiment, it is assumed that the calculated integrated score of product A is 75.2. The server pulls attribute information of product B according to the ID of product B and calculates an integrated score of product B according to the attribute information. For the calculating process, one may refer to description of the embodiment shown in FIG. 2. In this embodiment, it is assumed that the calculated integrated score of product B is 65.3. The server generates comparison information of product A and product B, and the comparison information may include the attribute information and the comparison information of each of product A and product B. Referring to FIG. 4c, it is an effect schematic diagram of a product comparison provided in yet another embodiment of the invention. The server returns the generated comparison information of product A and product B to the client terminal, then the client terminal may display a comparison information as shown in FIG. 4c in the comparison page. By browsing the comparison information in the comparison page, the user can know clearly key comparison points between product A and product B and obtain a comparison conclusion on product A and product B. Therefore, it is convenient to make a purchase decision. Preferably, this embodiment may provide a purchase link in the comparison page, then the user may click the link to purchase directly after making the purchasing decision. Thus, the transaction rate of the electronic commerce system can be increased.

In this embodiment of the present invention, the server pulls attribute information of at least two products which are requested to be compared, calculates an integrated score of each product, and generates comparison information including the attribute information and the integrated score of each product. The attribute information included in the comparison information of the product can clearly present to a user a key comparison point, and the integrated score included in the comparison information of the product can visually present to the user a comparison conclusion to assist the user in making a purchase decision. Thus, the actual effect and usage rate of the product comparison can be improved, and the intelligence of the electronic commerce system can be enhanced. Moreover, the user viscosity and the transaction rate of the electronic commerce system can be increased effectively.

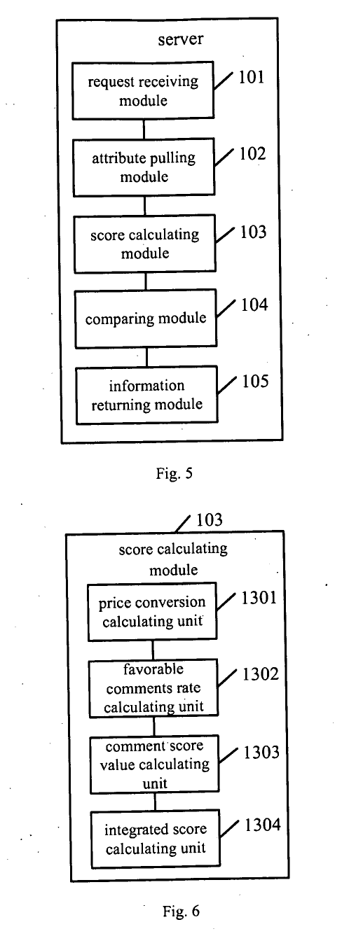

Below, detailed description of structures of servers provided in embodiments of the present invention will be provided in conjunction with FIGS. 5 and 6. It should be noted that the server below may be applied in the methods above.

Referring to FIG. 5, it is a structure schematic diagram of a server provided in yet another embodiment of the present invention. The server may comprise: a request receiving module 101, an attribute pulling module 102, a score calculating module 103, a comparing module 104 and an information returning module 105.

The request receiving module 101 is configured to receive a product comparison request sent by a client terminal, the product comparison request carrying identification information of at least two products which are to be compared. All of the at least two products may be standardizable-type products in the electronic commerce system, or all of the at least two products may be non-standardizable-type products in the electronic commerce system. Wherein, one product in the electronic commerce system corresponds to only one piece of identification information. The identification information of the product is used for identifying a unique product, and it may be an ID (Identity) of the product, a serial number of the product, etc.

The attribute pulling module 102 is configured to pull attribute information of each of the at least two products according to the identification information of each of the at least two products.

The server administrates attribute information of each product in the electronic commerce system, and the attribute information may include but not limited to: price information, comment information, product satisfaction information, promotion information, accumulated points information, feature information, product attention degree information and so on. Wherein, the comment information may include but not limited to: the quantity of positive comments, the quantity of neutral comments, the quantity of negative comments, the quantity of all comments and contents of the comments. The product satisfaction information may include but not limited to: a discount rate, a size satisfaction degree, a comfort level, a trueness degree of a picture, and a trueness degree of a product description. The attribute pulling module 102 pulls attribute information of each of the at least two products according to the identification information of each of the at least two products. It should be noted that, in this embodiment, comparison points which a user concerns about when the user performs a product comparison may be collected based on experiences, and all or part of the attribute information of each of the at least two products may be pulled according to the collection result.

The score calculating module 103 is configured to calculate an integrated score of each of the at least two products according to the attribute information of each of the at least two products.

The score calculating module 103 calculates the integrated score of each of the at least two products by using the attribute information of each of the at least two products as a calculation factor of the integrated score of each product. It should be noted that, the integrated score may visually reflect the advantages and disadvantages of a product. The higher the integrated score is, the higher the comprehensive performance of the product is, and the more the product is deserved of trust and purchasing.

The comparing module 104 is configured to generate comparison information of the at least two products, the comparison information comprising the attribute information and the integrated score of each of the at least two products.

Wherein, the comparison information of the at least two products is the comparison result of the at least two products. The comparison result includes not only attribute information of each of the at least two products, which clearly reflects key comparison points, but also the integrated score of each of the at least two products, which visually reflects the advantages and disadvantages of each product.

The information returning module 105 is configured to return the comparison information of the at least two products to the client terminal.

After the information returning module 105 returns the comparison information to the client terminal, the client terminal may output the comparison information in a comparison page. The comparison information not only presents key comparison points of products clearly, but also presents a comparison result to the user visually, assisting a user in making a purchasing decision and increasing a transaction rate of the electronic commerce system.

In this embodiment of the present invention, the server pulls attribute information of at least two products which are requested to be compared, calculates an integrated score of each product, and generates comparison information including the attribute information and the integrated score of each product. The attribute information included in the comparison information of the product can clearly present to a user a key comparison point, and the integrated score included in the comparison information of the product can visually present to the user a comparison conclusion to assist the user in making a purchase decision. Thus, the actual effect and usage rate of the product comparison can be improved, and the intelligence of the electronic commerce system can be enhanced. Moreover, the user viscosity and the transaction rate of the electronic commerce system can be increased effectively.

Referring to FIG. 6, it is a structure schematic diagram of a score calculating module shown in FIG. 5 provided in yet another embodiment of the present invention. The score calculating module 103 may comprise: a price conversion calculating unit 1301, a positive comment rate calculating unit 1302, a comment score value calculating unit 1303 and an integrated score calculating unit 1304.

The price conversion calculating unit 1301 is configured to calculate a price conversion value of each of the at least two products according to the price information of each of the at least two products.

Wherein, the price conversion value refers to a value obtained by converting the price of a product with a certain value as a base value. The certain value may be set according to actual needs. For example, the certain value may be 100, 200, and so on. The process that the price conversion calculating unit 1301 calculates the price conversion value of each of the at least two products may comprise: firstly, the price conversion calculating unit 1301 selects, according to the price information of each of the at least two products, product m corresponding to the highest price from the at least two products, the price conversion value of product m may be expressed by formula (1) in the afore-mentioned embodiments of methods. Secondly, the price conversion calculating unit 1301 may calculate the price conversion value of product i, which is any one of the at least two products except product m, using formula (2) in the afore-mentioned embodiments of methods.

The positive comment rate calculating unit 1302 is configured to calculate a positive comment rate of each of the at least two products using the Wilson interval formula according to the comment information of each of the at least two products. The process that the positive comment rate calculating unit 1302 calculates the positive comment rate of any one of the at least two products includes: firstly, according to the quantity of positive comment and the quantity of all comments which are included in the comment information of product k, the positive comment rate calculating unit 1302 calculates the positive comment percentage of product k using formula (3) in the afore-mentioned embodiments of methods; secondly, according to the positive comment percentage and the quantity of all comments of product k, the positive comment rate calculating unit 1302 calculates to obtain the positive comment rate of product k using formula (4) in the afore-mentioned embodiments of methods. The comment score value calculating unit 1303 is configured to calculate a comment score value of each of the at least two products using a semantic analysis algorithm, according to the comment information of each of the at least two products.

Wherein, the semantic analysis algorithm means analyzing semantics of keywords in a comment and giving a corresponding score value to each key word according to the analysis result. In this embodiment, score values corresponding to different key words may be set beforehand as shown in table 1 in the above embodiment of the method according to actual situations. Firstly, the comment score value calculating unit 1303 may extract the key words from the comment of each product according to the comment of each of the at least two products. Secondly, the comment score value calculating unit 1303 may read the corresponding score value of each key word from the above table 1. Thirdly, the comment score value calculating unit 1303 calculates the total score value of all key words corresponding to each product to obtain the comment score value of each product. For instance, the comment score value calculating unit 1303 may extract a first key word, a second key word, and a third key word for product k, which is any one of the at least two products. Then, a first score value, a second score value and a third score value are obtained according to the above table 1. So, the comment score value of product k calculated by the comment score value calculating unit 1303 is the sum of the first score value, the second score value and the third score value.

The integrated score calculating unit 1304 is configured to calculate the integrated score of each of the at least two products using a product integrated scoring algorithm, according to the price conversion value, the positive comment rate, the comment score value and the product satisfaction information.

The integrated score calculating unit 1304 may obtain the integrated score of product j, which is any one of the at least two products, by calculation according to the integrated score calculating formula shown in formula (5) in the afore-mentioned embodiments of methods.

It should be noted that, the structures and functions of the server provided in this embodiment may be implemented specifically according to the methods shown in embodiments in FIGS. 1-2 and FIG. 4. For the specific implementation, one may refer to relevant description of the embodiments above, which will not be described here to avoid redundancy.

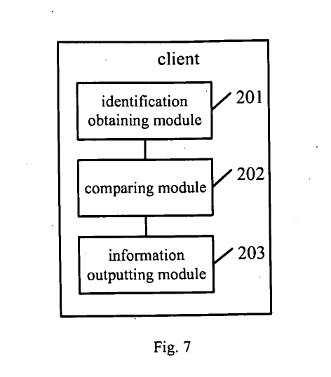

In this embodiment of the present invention, the server calculates the integrated score of each product according to the attribute information of the at least two products which are to be compared. In this way, the integrated score can be included in the comparison information of a product, presenting to a user the comparison conclusion visually to assist the user in making a purchase decision. Thus, the actual effect and usage rate of the product comparison can be improved, and the intelligence of the electronic commerce system can be enhanced. Moreover, the user viscosity and the transaction rate of the electronic commerce system may be increased effectively. Detailed description of a structure of a client terminal provided in yet another embodiment of the present invention will be given below in conjunction with FIG. 7. It should be noted that the client terminal below may be applied in the methods above. Referring to FIG. 7, it is a structure schematic diagram of a client terminal provided in yet another embodiment of the present invention. The client terminal may comprise: an identification obtaining module 201, a comparing module 202 and an information outputting module 203.

The identification obtaining module 201 is configured to obtain identification information of at least two products which are to be compared when the client terminal detects a product comparison operation in an electronic commerce system. At present, in an electronic commerce system, it is usually provided an option for product comparison operation, for example: an option of “product comparison”, an option of “compare products” and so on. A user may select at least two products to perform a product comparison according to the option for product comparison operation provided in the electronic commerce system. The identification obtaining module 201 obtains identification information of at least two products which are to be compared when detecting a product comparison operation in the electronic commerce system. All of the at least two products may be standardizable-type products in the electronic commerce system, or all of the at least two products may be non-standardizable-type products in the electronic commerce system. Wherein, one product in the electronic commerce system corresponds to only one piece of identification information. The identification information of the product is used for identifying one product uniquely and may be an ID of the product, a serial number of the product, etc.

The comparing module 202 is configured to send a product comparison request carrying the identification information of the at least two products to a server, so as to make the server pull attribute information of each of the at least two products, calculate an integrated score of each of the at least two products, and generate comparison information of the at least two product to send the comparison information to the client terminal.

The comparing module 202 sends a product comparison request to the server, the product comparison request carrying the identification information of the at least two products which are to be compared. It should be noted that, after receiving the product comparison request sent by the client terminal, the server will perform the process of pulling the attribute information of the product, calculating the integrated score of the product, generating the comparison information of the product and returning the comparison information to the client terminal.

The information outputting module 203 is configured to output comparison information of the at least two products in a comparison page, the comparison information being returned by the server.

The information outputting module 203 outputs the comparison information of the at least two products in a comparison page. Then, by browsing the comparison information in the comparison page, a user may not only know clearly key comparison points between products, but also obtain a comparison conclusion on the products. Thus, the user may make a purchase decision easily and the transaction rate of the electronic commerce system can be increased.

It should be noted that, the structures and functions of the client terminal provided in this embodiment may be implemented specifically with the methods shown in embodiments in FIGS. 3 and 4. For the specific implementation, one may refer to relevant description of the embodiments above, which will not be described here to avoid redundancy.

In this embodiment of the present invention, when detecting a product comparison operation in the electronic commerce system, the client terminal obtains the identification information of the at least two products which are to be compared and outputs the comparison information of the at least two products in the comparison page, the comparison information being sent by the server. Wherein, the attribute information of products included in the comparison information can clearly present to a user the key comparison points, and the integrated scores of the products included in the comparison information can visually present to the user a comparison conclusion to assist the user in making a purchase decision. Thus, the actual effect and usage rate of the product comparison can be improved, and the intelligence of the electronic commerce system can be enhanced. Moreover, the user viscosity and the transaction rate of the electronic commerce system can be increased effectively.

According to yet another embodiment of the invention, it is also provided an electronic commerce system, which comprises at least two products: a server and at least one client terminal. Wherein, for the structure of the server, one may refer to relevant description of the embodiments shown in FIGS. 5 and 6, and for the structure of the client terminal, one may refer to relevant description of the embodiments shown in FIG. 7, which will not be described here to avoid redundancy.

According to the description of the embodiments above, in this embodiment, the server pulls attribute information of at least two products which are requested to be compared, calculates an integrated score of each product, and generates comparison information including the attribute information and the integrated score of each product. The attribute information included in the comparison information of the product can clearly present to a user a key comparison point, and the integrated score included in the comparison information of the product can visually present to the user a comparison conclusion to assist the user in making a purchase decision. Thus, the actual effect and usage rate of the product comparison can be improved, and the intelligence of the electronic commerce system can be enhanced. Moreover, the user viscosity and the transaction rate of the electronic commerce system can be increased effectively.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention. Therefore, the scope of the present invention shall be subject to be appended claims.

1. A method for product comparison, comprising the steps of:
receiving, at a server, a product comparison request sent by a client terminal, the product comparison request carrying identification information of at least two products which are to be compared;
pulling, at the server, attribute information of each of the at least two products according to the identification information of each of the at least two products;
calculating, at the server, an integrated score of each of the at least two products according to the attribute information of each of the at least two products; and
generating, at the server, comparison information of the at least two products, and returning the comparison information to the client terminal, the comparison information comprising the attribute information and the integrated score of each of the at least two products.

2. The method of claim 1, wherein the attribute information comprises: price information, comment information, and product satisfaction information.

3. The method of claim 2, wherein the comment information comprises: a quantity of positive comments, a quantity of all comments, and contents of a comment; and the product satisfaction information comprises: a discount rate, a size satisfaction degree, a comfort degree, and a trueness degree of a picture.

4. The method of claim 3, wherein the step of calculating, at the server, the integrated score of each of the at least two products according to the attribute information of each of the at least two products, comprising:
calculating, at the server, a price conversion value of each of the at least two products according to the price information of each of the at least two products;
calculating, at the server, a positive comment rate of each of the at least two products using the Wilson interval formula according to the comment information of each of the at least two products;
calculating, at the server, a comment score value of each of the at least two products using a semantic analysis algorithm according to the comment information of each of the at least two products; and
calculating, at the server, the integrated score of each of the at least two products using a product integrated scoring algorithm according to the price conversion value, the positive comment rate, the comment score value, and the product satisfaction information.

5. The method of claim 1, wherein all of the at least two products are standardizable-type products in an electronic commerce system, or all of the at least two products are non-standardizable-type products in the electronic commerce system.

6. A method of product comparison, comprising the steps of:
obtaining, at a client terminal, identification information of at least two products which are to be compared when the client terminal detects a product comparison operation in an electronic commerce system;
sending, at the client terminal, a product comparison request carrying the identification information of the at least two products to a server, so as to make the server pull attribute information of each of the at least two products, calculate an integrated score of each of the at least two products, and generate comparison information of the at least two products to return the comparison information to the client terminal; and
outputting, at the client terminal, comparison information of the at least two products in a comparison page, the comparison information being returned by the server.

7. The method of claim 6, wherein all of the at least two products are standardizable-type products in an electronic commerce system, or all of the at least two products are non-standardizable-type products in the electronic commerce system.

8. A server, comprising:
a request receiving module, which is configured to receive a product comparison request sent by a client terminal, the product comparison request carrying identification information of at least two products which are to be compared;
an attribute pulling module, which is configured to pull attribute information of each of the at least two products according to the identification information of each of the at least two products;
a score calculating module, which is configured to calculate an integrated score of each of the at least two products according to the attribute information of each of the at least two products;
a comparing module, which is configured to generate comparison information of the at least two products, the comparison information comprising the attribute information and the integrated score of each of the at least two products; and
an information returning module, which is configured to return the comparison information of the at least two products to the client terminal.

9. The server of claim 8, wherein the attribute information comprises: price information, comment information and product satisfaction information.

10. The server of claim 9, wherein the comment information comprises: a quantity of positive comments, a quantity of all comments and contents of a comment; and the product satisfaction information comprises: a discount rate, a size satisfaction degree, a comfort degree and a trueness degree of a picture.

11. The server of claim 10, wherein the score calculating module comprises:
a price conversion calculating unit, which is configured to calculate a price conversion value of each of the at least two products according to the price information of each of the at least two products;
a positive comments rate calculating unit, which is configured to calculate a positive comment rate of each of the at least two products using the Wilson interval formula according to the comment information of each of the at least two products;
a comment score value calculating unit, which is configured to calculate a comment score value of each of the at least two products using a semantic analysis algorithm according to the comment information of each of the at least two products; and
an integrated score calculating unit, which is configured to calculate the integrated score of each of the at least two products using a product integrated scoring algorithm according to the price conversion value, the positive comment rate, the comment score value and the product satisfaction information.

12. The server of claim 8, wherein all of the at least two products are standardizable-type products in an electronic commerce system, or all of the at least two products are non-standardizable-type products in the electronic commerce system.

13. A client terminal, comprising:
an identification obtaining module, which is configured to obtain identification information of at least two products which are to be compared when the client terminal detects a product comparison operation in an electronic commerce system;
a comparing module, which is configured to send a product comparison request carrying the identification information of the at least two products to a server, so as to make the server pull attribute information of each of the at least two products, calculate an integrated score of each of the at least two products, and generate comparison information of the at least two products to send the comparison information to the client terminal; and
an information outputting module, which is configured to output comparison information of the at least two products in a comparison page, the comparison information being returned by the server.

14. The client terminal of claim 13, wherein all of the at least two products are standardizable-type products in an electronic commerce system, or all of the at least two products are non-standardizable-type products in the electronic commerce system.

15. (canceled)

16. The method of claim 2, wherein all of the at least two products are standardizable-type products in an electronic commerce system, or all of the at least two products are non-standardizable-type products in the electronic commerce system.

17. The method of claim 3, wherein all of the at least two products are standardizable-type products in an electronic commerce system, or all of the at least two products are non-standardizable-type products in the electronic commerce system.

18. The method of claim 4, wherein all of the at least two products are standardizable-type products in an electronic commerce system, or all of the at least two products are non-standardizable-type products in the electronic commerce system.

19. The server of claim 9, wherein all of the at least two products are standardizable-type products in an electronic commerce system, or all of the at least two products are non-standardizable-type products in the electronic commerce system.

20. The server of claim 10, wherein all of the at least two products are standardizable-type products in an electronic commerce system, or all of the at least two products are non-standardizable-type products in the electronic commerce system.

21. The server of claim 11, wherein all of the at least two products are standardizable-type products in an electronic commerce system, or all of the at least two products are non-standardizable-type products in the electronic commerce system.
